(19) United States
(12) Patent Application Publication
(10) Pub. No.: US 2025/0124251 A1
(43) Pub. Date: Apr. 17, 2025

(54) COURSE OF ACTION SUPPORT TECHNOLOGY ARCHITECTURES

(71) Applicant: Raytheon Company, Tewksbury, MA (US)

(72) Inventors: Paul C. Hershey, Ashburn, VA (US); Charles L. Taylor, Falls Church, VA (US); David Morrison, Aldie, VA (US); Jennifer N. Coston, Ashburn, VA (US); Rachel D. Coston, Ashburn, VA (US)

(21) Appl. No.: 18/487,755

(22) Filed: Oct. 16, 2023

(51) Int. Cl. G06N 3/006

(52) U.S. Cl. CPC G06N 3/006

(57) ABSTRACT

Systems, devices, methods, and computer-readable media for course of action (COA) analysis and execution. A method can include receiving COA data, coordinating, by an orchestrator service, simulation of performing COAs associated with the COA data, generating a graphical view of the simulation of the COAs including scores associated with each COA, implementing a COA of the COAs selected by the commander, receiving, from multiple applications information regarding a state of executing the COA, and providing a graphical view of the state of executing the COA including an overall map of a geographical region in which the COA is implemented, the graphical view including a dynamic location of the threat and threat mitigation activities, and a dynamic view of the LOS updated as the COA is implemented.

### TECHNICAL FIELD

Embodiments help military Commanders achieve decision dominance across all warfighting functions including synchronization and coordination of all echelons. Synchronization and coordination of plans and execution can be performed on an improved Commander user interface (UI) that operates based on data provided by an improved course of action support technology architecture. The UI can provide improved course of action support on a single pane of glass (SPOG) in an integrated common operational picture across the echelons.

### BACKGROUND

Military commanders typically manually develop courses of action (COAs) to use assets (e.g., vehicles, weapons, soldiers, etc.) to achieve a goal. COA designers typically need to process large amounts of data in little time, leading to error or sub-optimized solutions. As the foregoing illustrates, machine-implemented COA development and analysis may be desirable.

A COA considers threats and corresponding effects that can neutralize the threats. When assessing the success of one or more effects (e.g., kinetic effects, non-kinetic effects, or a combination thereof) against threats (e.g., kinetic threats, non-kinetic threats, or a combination thereof) a mathematical characterization of such effect-threat pairings helps to achieve an objective assessment of the effectiveness of the effects. The effectiveness can include success of those effects neutralizing the threats to which they are paired.

Threats evolve, and as a threat evolves the form of a model of the threat typically changes. Also, for different given threats, the form of the model of the threat is generally different. A normalized form for various, different, and evolving models would help compatibility, understandability, deployment, and would help reduce complexity.

There are many algorithms for determining a threat-danger assessment. However, these algorithms are specific to a given (threat, effect) pairing and apply to a specific scenario (e.g., Concept of Operations (CONOPS) or Concept of Employment (COE)), and to a specific mission phase. For the example of Joint All Domain Command and Control (JADC2) or missile defense these phases can include manufacturing, fielding and deployment, boost, midcourse, and terminal. Presently, to the best of the knowledge of the inventors, there is no method or technique to assure that results of these diverse assessment algorithms can be combined in a meaningful way to provide an overall mission assessment. This issue impacts mission effectiveness and impedes successful execution of the mission in a timely manner.

### BRIEF DESCRIPTION OF DRAWINGS

FIG. 1 illustrates, by way of example, a diagram of an embodiment of a flowchart for wholistic, multi-domain COA coordination and support.

FIG. 2 illustrates, by way of example, a diagram of an embodiment of a system for implementing the flowchart of FIG. 1.

FIG. 3 illustrates, by way of example, a diagram of an embodiment of a commander interface system.

FIG. 4 illustrates, by way of example, a diagram of an embodiment of a system for performing operation 104 of FIG. 1.

FIG. 5 illustrates, by way of example, a diagram of an embodiment of a chart for activity synchronization, the operation.

FIG. 6 illustrates, by way of example, a diagram of an embodiment of a graphical view of a mission simulation showing selection of analysis components.

FIG. 7 illustrates, by way of example, a diagram of an embodiment of a system determining the LOS, at operation.

FIGS. 8 and 9 illustrate, by way of example, diagrams of respective views that can be provided on the UI as a result of the operation.

FIG. 10 illustrates, by way of example, a diagram of an embodiment of a system 1000 to perform operation 116.

FIG. 11 illustrates, by way of example, a diagram of an embodiment of a method 1100 for [symbol] .

FIG. 12 is a block diagram of an example of an environment including a system for neural network (NN) training.

FIG. 13 illustrates, by way of example, a block diagram of an embodiment of a machine in the example form of a computer system 400 within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

What is needed is a capability that converges functions across domains (e.g., ARMY or land, NAVY or water, AIR FORCE or air, SPACE FORCE or space, MARINES, cyber, or the like) and echelons (e.g., troops or assets, lieutenant, ensign, major, lieutenant commander, lieutenant colonel, battalion commander, unit commander, colonel, captain, general, admiral etc.) to increase speed, scale, accuracy and confidence for multi-domain operations from (i) planning to execution and (ii) intelligence to firing of an effect. Embodiments provide such a capability by, from a user's perspective, includes a UI that provides a interactive wholistic view of a battlespace on a single pane of glass (SPOG) (e.g., a single display device). Embodiments provide such a capability by using a computer architecture to interface with tools that are typically specific to a single domain and then combining data from each of the tools to a common format. Embodiments can receive user input, operate on the combined data, and provide the wholistic view through the UI. The UI, computer architecture, or a combination thereof provide a new approach to ingest, fuse, and coordinate data across multiple battlespace domains (e.g., air, land, sea, space, and cyber) and associated assets and entities. The UI, computer architecture, or a combination thereof accelerates decision making as compared to prior autonomous and manual decision techniques. The UI, computer architecture, or a combination thereof provide new activity synchronization and coordination possibilities. The UI, computer architecture, or a combination thereof supports planning and execution across all echelons and domains. The UI can provide results on a single pane of glass and in an integrated common operational picture. This improvement provides simplicity and convenience for the commander that reduces complexity and improves time to decision. The simplicity and time to decision improvements are provided relative to prior solutions that correspond to a single echelon or single domain. The UI, computer architecture, or a combination thereof provide a new approach for computing mission success using user-selectable artificial intelligence (AI) or machine learning (ML) techniques. The UI, computer architecture, or a combination thereof provide high fidelity results for all aspects of all domains and echelons of the mission. The UI, computer architecture, or a combination thereof can provide corresponding confidence levels to aid the commander in understanding reliability of the likelihoods of success provided by the UI, computer architecture, or a combination thereof.

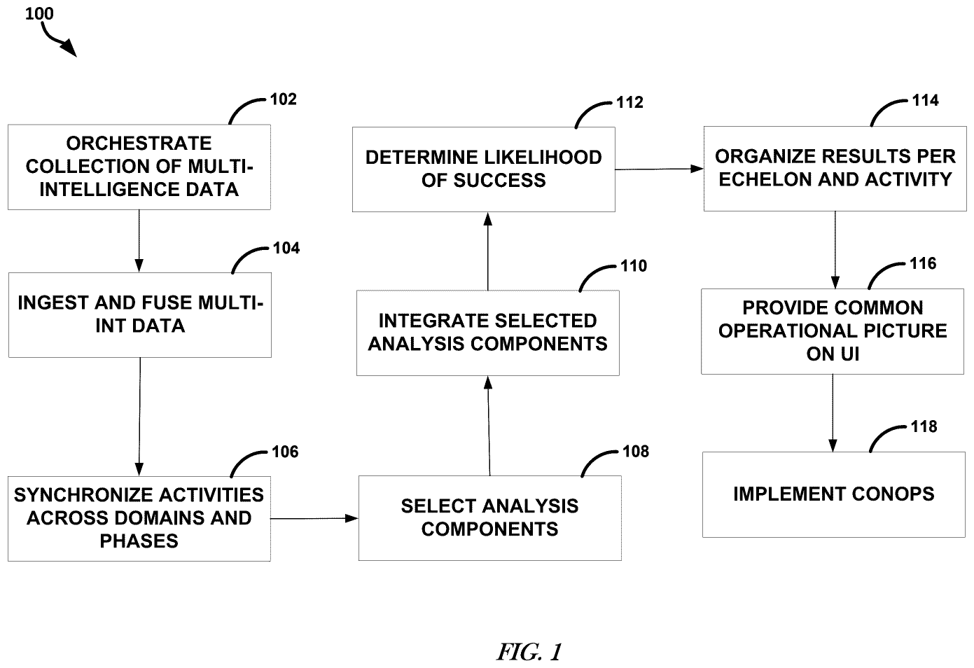

FIG. 1 illustrates, by way of example, a diagram of an embodiment of a flowchart 100 for wholistic COA support. The flowchart 100 shows, at a high level, the operations performed to provide the wholistic view on the UI. Other diagrams and disclosure describe potential details and description of how the operations can be performed and advantages provided by performing each operation in the manner described.

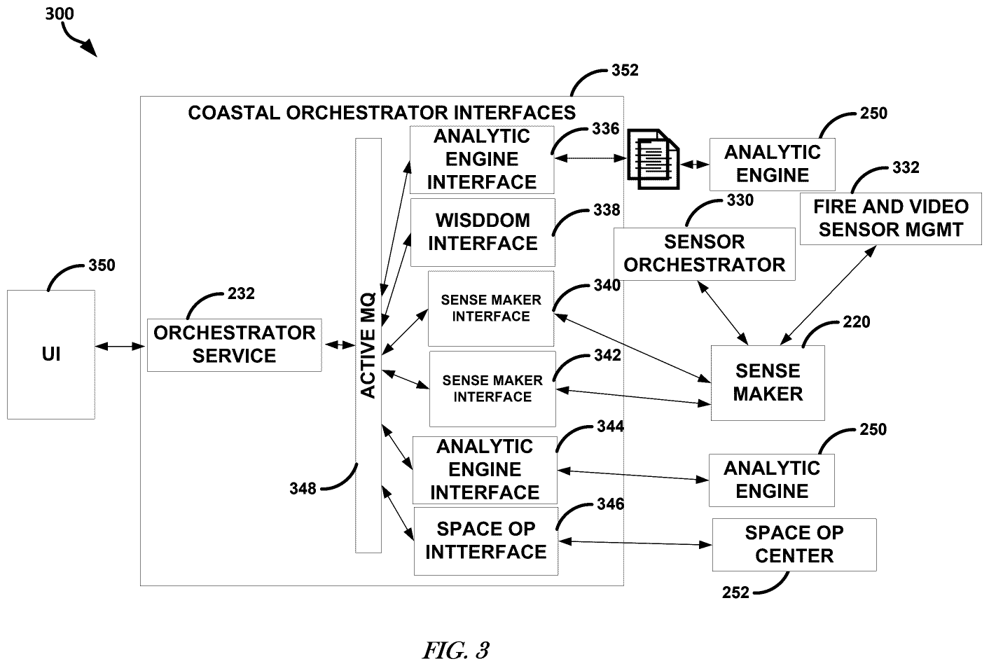

The flowchart 100 as illustrated includes orchestrating collection of multi-intelligence data, at operation 102. An interface architecture 300 for performing the operation 102 is provided in FIG. 3. The operation 102 can include receiving intelligence data from sensor platforms, weather stations, satellites, communications devices, or the intelligence devices, such as autonomous vehicles. The intelligence data can be from each of a plurality of domains and relevant to multiple echelons of assets, entities, and personnel of the battlefield.

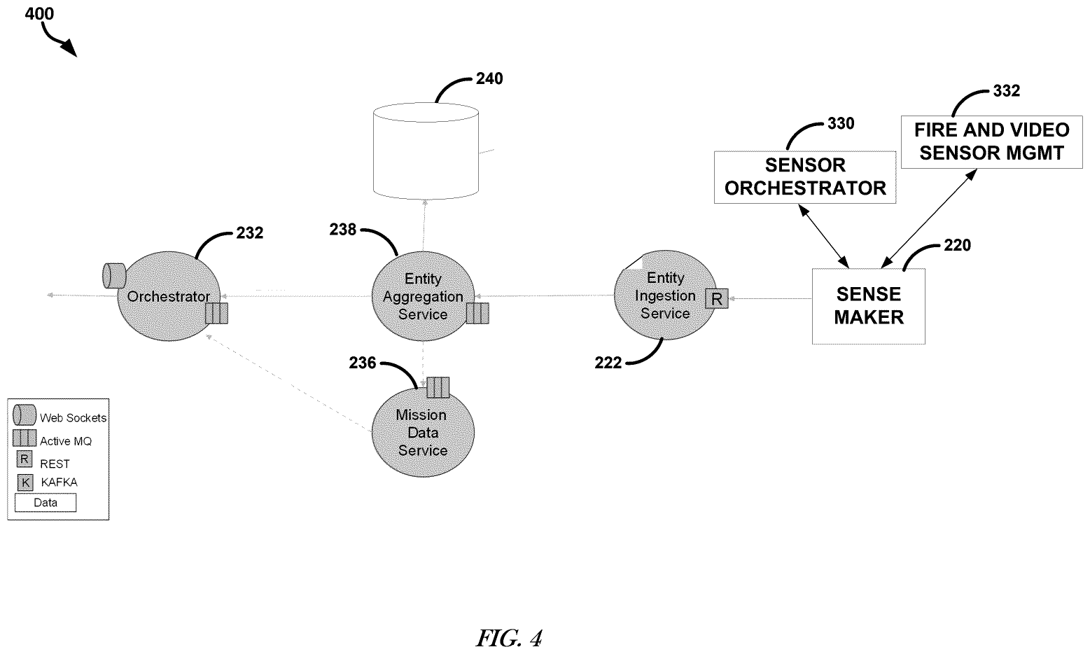

At operation 104, the intelligence data from operation 102 can be ingested and fused. Ingestion typically includes receiving and formatting the intelligence data into a common format. Times, units, or the like, can be converted to a common format that can be default of specified by the commander. As different domains and echelons prefer to disseminate and receive data in different formats, it is important to convert the intelligence data to a common format so that comparison is meaningful. FIG. 4 provides more details and description of embodiments for performing the operation 104.

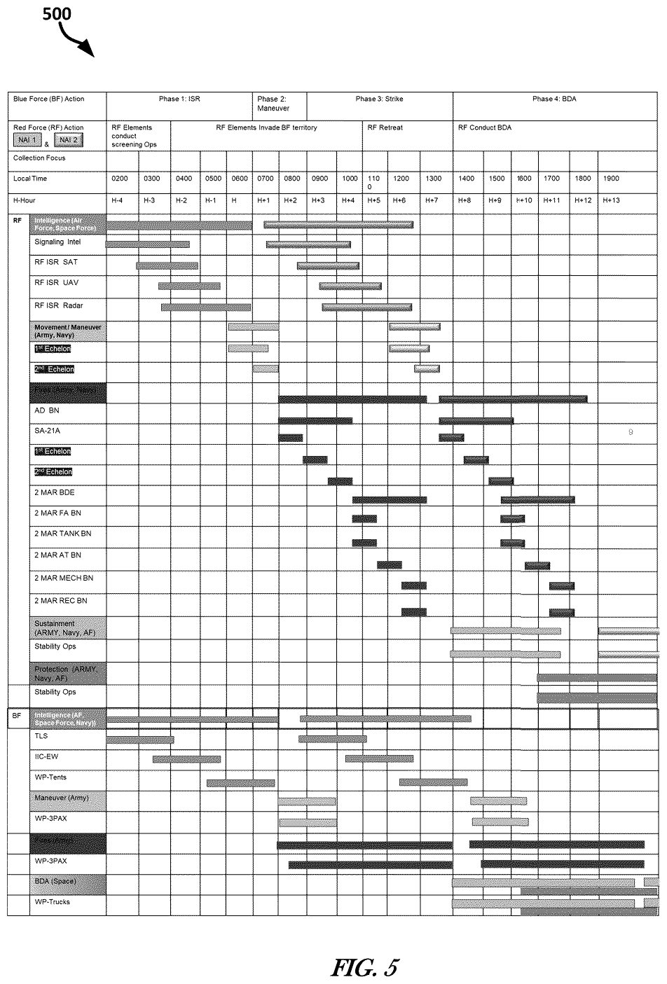

At operation 106, the activities of all echelons of all domains are synchronized across all phases of the mission. Synchronization means time synchronization. The operation 106 can include providing a view of the activities performed by each echelon of each domain that is organized temporally. The view can include a matrix-like view in which time progresses across columns and different activities are represented on different rows. FIG. 5 provides more details and description for performing the operation 106.

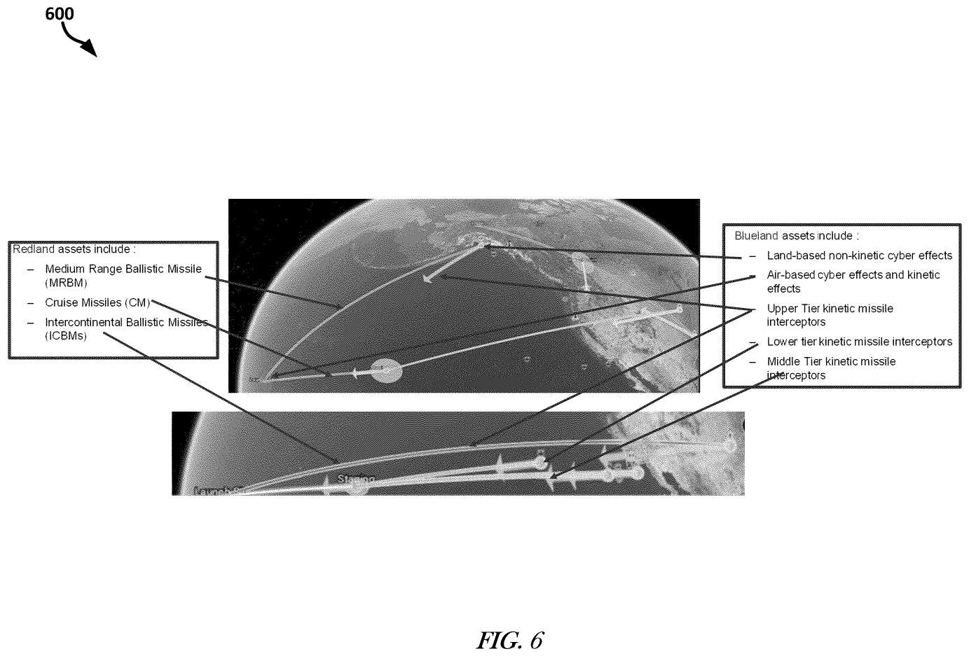

At operation 108, the commander can be presented with a UI that provides the temporally-organized view of activities. The commander, through the UI, can add, remove, or otherwise modify an activity in the view of the activities. The commander can add or remove activities for any domain or echelon. The result of the commander interacting with the UI is a scenario, sometimes called a concept of operations (CONOPS). The operation 108 can further include the commander selecting analysis techniques, such as AI or ML analysis techniques that are to be incorporated into the analysis of a likelihood of success (LOS) for the CONOPS. FIG. 6 provides more details and description for performing the operation 108.

At operation 110, computing tools associated with the activities and analysis selections provided by the commander can be integrated into an analysis platform. Integration into the analysis platform includes coordination and execution of the compute tools (e.g., which tool operates on what input and what output of what tool is provided to another tool or provided as output to the commander). In different scenarios, the tools can operate on different inputs and can operate in different orders to provide accurate results. The operation 110 ensures that the operations are performed on the correct data and in the correct order.

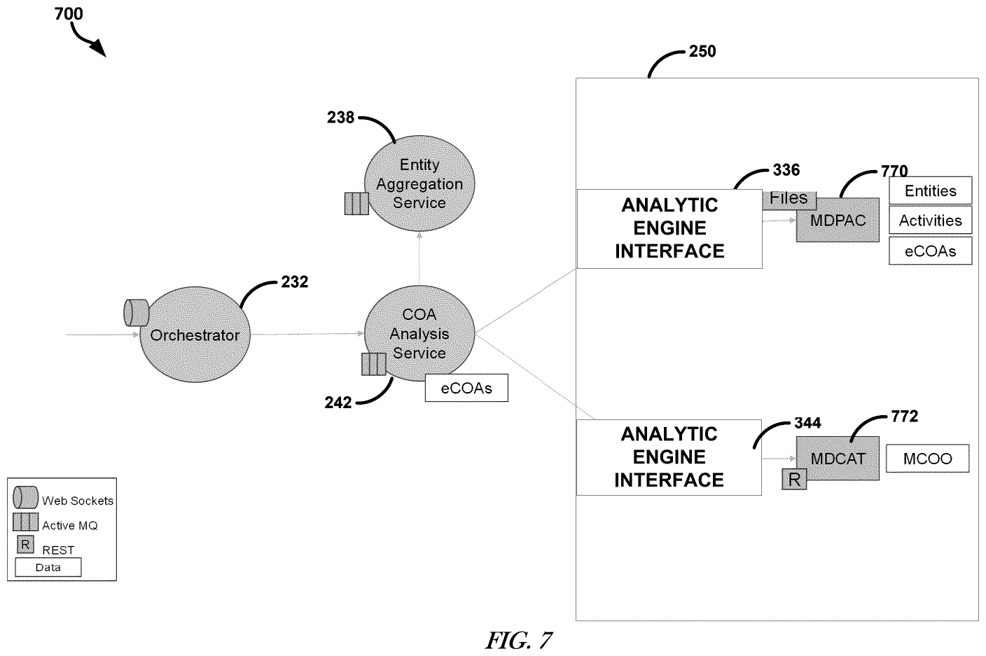

At operation 112, the compute tools can be executed to determine a LOS for each activity. The LOS can be hierarchical such that LOS from individual activities can be combined to determine an LOS for an echelon, and LOS for echelons can be combined to determine an LOS for a domain, and LOS for domains can be combined to determine and LOS for a mission. Each hierarchical level can also include a corresponding confidence. FIG. 7 provides more details and description for performing the operation 112.

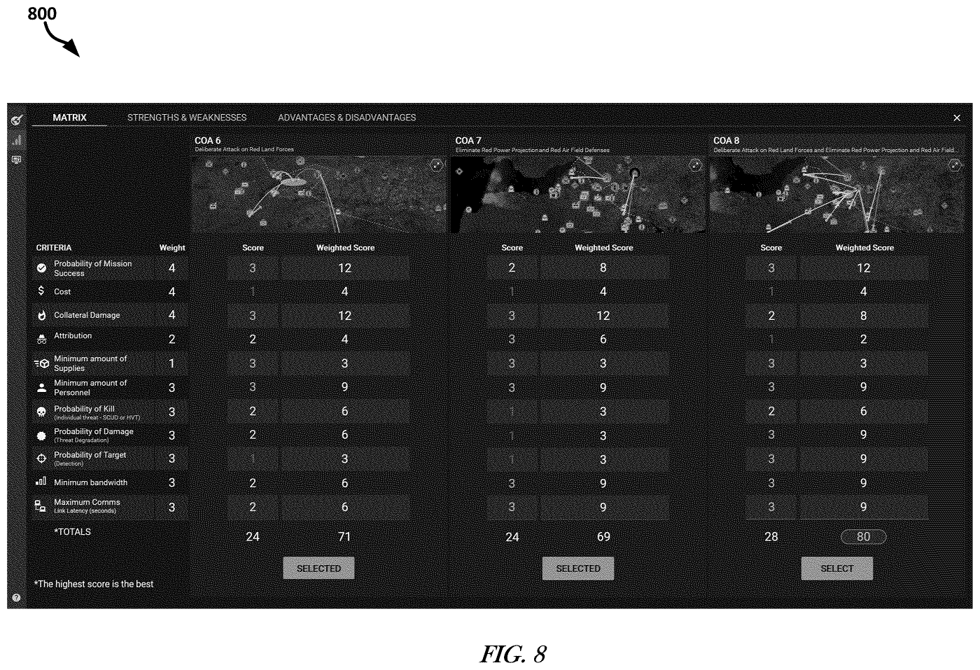

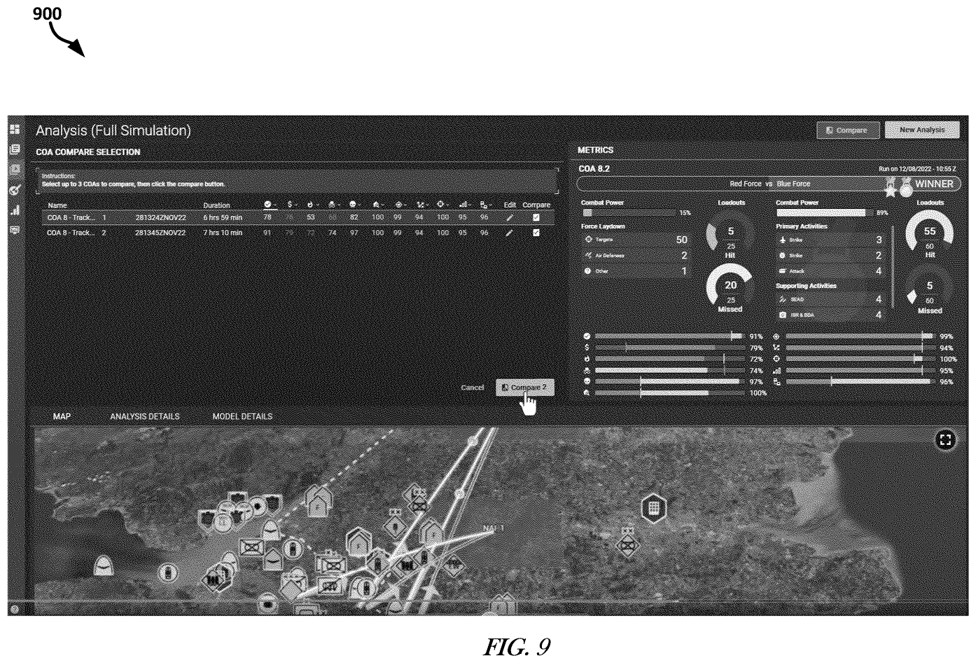

At operation 114, the results can be organized per activity, echelon, domain, mission, or the like. The hierarchical organization of the results provides the commander with an intuitive, understandable, and easy to navigate way of identifying strengths and weaknesses in the CONOPS. In this way, the commander can get an idea of what domain, echelon, or activity is problematic in their definition of the CONOPS. An explanation for a confidence or LOS that is below a pre-defined threshold can be provided. The explanation can include weather, threat, operational ability of an asset insufficient, or the like. The explanation can help a commander identify or otherwise adjust an activity or a series of activities to a CONOPS that will increase the LOS, confidence, or a combination thereof. FIGS. 8 and 9 provide more detail and description for performing the operation 114.

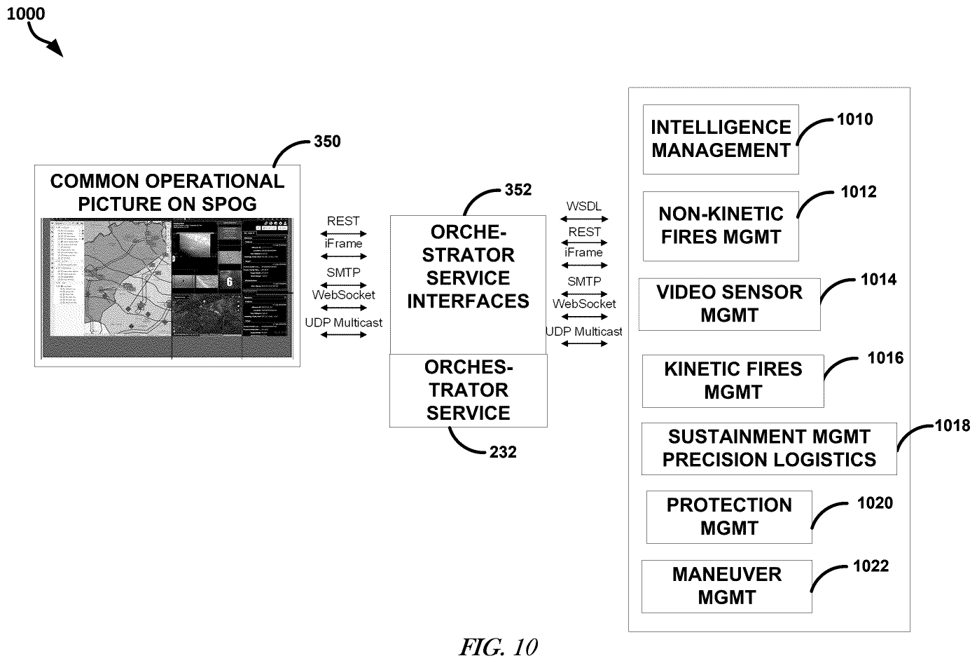

At operation 116, a common operational picture (COP) can be provided to the commander on the UI. The COP can include all information relevant to the CONOPS on a SPOG. The COP is interactive and configurable and provides interfaces to all activities of all domains. The COP provides the commander with a wholistic view of the mission, not just a view of activities of a single domain. FIG. 10 provides more detail and description for performing the operation 116.

At operation 118, the CONOPS, with the approval of the commander, can be implemented. Implementing the CONOPS includes communicating instructions to assets, entities or the like. The instructions include actions and timelines for performing the actions in accord with the synchronized activities approved by the commander. In some instances, such as communicating instructions to an entity, a communication device relays the instructions to the entity. In other instances, a command instruction is related to a device that causes the device to perform the actions in accord with the synchronized activities.

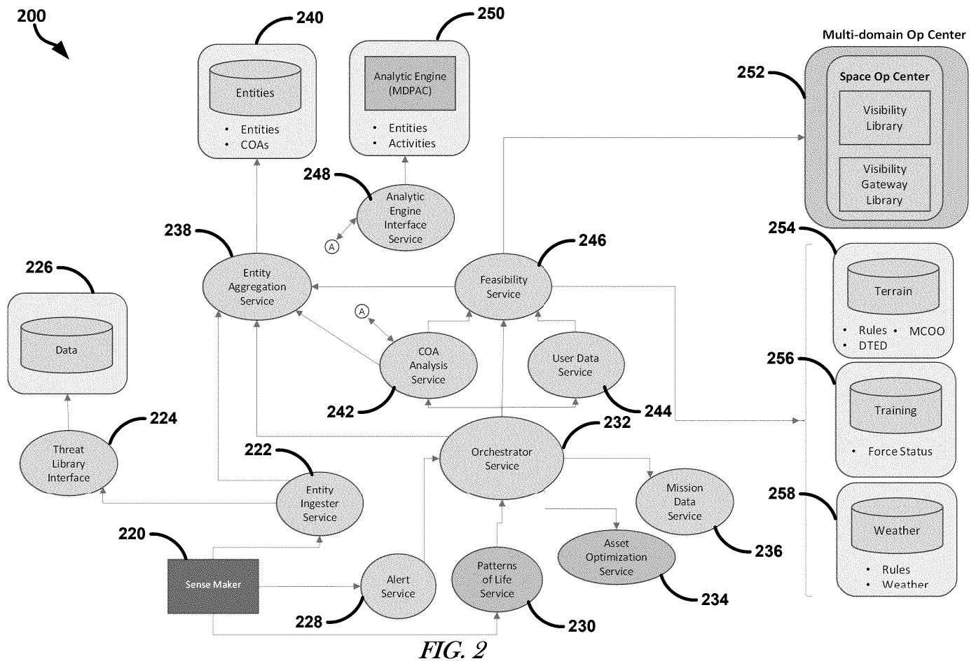

FIG. 2 illustrates, by way of example, a diagram of an embodiment of a portion of a system 200 for implementing the flowchart 100 of FIG. 1. The system 200 operates based on commands that flow through the orchestrator service 232 that provides views to a commander UI (see FIG. 3). The system 200 as illustrated includes an orchestrator service 232 that interfaces with a plurality of other services. The orchestrator service 232 collects, organizes, and formats data to be presented on the UI (see FIG. 3). A “service” in the context of FIG. 2 is a computer application that interfaces with another service, device, or a combination thereof to provide a result that is ultimately useful to the commander. The orchestrator service 232 performs the operation 102 of the flowchart of FIG. 1. The orchestrator service 232, as illustrated in FIG. 2 communicates with an alert service 228, a patterns of life service 230, an asset optimization service 234, a mission data service 236, a user data service 244, a COA analysis service 242, and an entity aggregation service 238.

The alert service 228 receives ingests alerts from a sense maker 220 and provides the alerts to the orchestrator service 232. The alerts regard respective changes in geographic location of an entity in battlespace. The sense maker 220 interfaces with persistent intelligence, surveillance, and reconnaissance (ISR) equipment. The sense maker 220 analyzes the data provided by the persistent ISR equipment to identify any changes in the battlefield and relay those changes to the alert service 228, and possibly other services. The alert service 228 is an application programming interface (API) that alters the format of the alerts from the sense maker 220 to a form compatible with the orchestrator 232.

The sense maker 220 can identify new entities in the persistent ISR data. Data corresponding to a new entity in the persistent ISR data can be provided to an entity ingester service 222. The entity ingester service 222 facilitates data collection regarding entities. Note that an entity may correspond to a person, an object, or a combination thereof. Some entities are potential threats and such potential threats can be provided to a threat database 226 through a threat library interface 224. The threat library interface 224 is an API that formats data from the entity ingester service 222 into a form compatible with the threat database 226. Sometimes a threat is previously known and reappears in the persistent ISR data. To determine if a threat was previously known, the entity ingester service 222 can query the database 226, such as through the threat library interface 224. If a threat was previously known, the details regarding the threat can be provided to the entity ingester service 222. The threats in the database 226 can be indexed by entity type. Example entity types include weapons, people, or support equipment. Some entities are known to be not threats, such as by the sense maker 220. Such entities can be labeled accordingly, such as by the sense maker 220, the entity ingester service 222 or a combination thereof. Details of threats stored in the threat database 226 can include capabilities of the threats, such as range, resolution, frequency, power consumption, mobility, damage potential, among others. The threats can include kinetic and non-kinetic threats. Kinetic threats include radar, communications services, missiles, airplanes, helicopters, tanks, other weapons, or the like. Non-kinetic threats includes electronic warfare jammers, a cyber virus, or the like.

The entity ingester service 222 can communicate entity data from the sense maker 220 and the database 226 to an entity aggregation service 238. The entity aggregation service 238 reads from and writes to an entities database 240. The entity aggregation service 238 is an API that receives read and write requests and manages and formats the read and write requests in a format compatible with the database 240. The entity aggregation service 238 can receive write requests from the entity ingester service 222. The entity aggregation service 238 can receive read requests from the orchestrator service 232, COA analysis service 242 and feasibility service 246. Details of the entities stored in the entity database 240 can include entity type, entity domain (air, land, sea, etc.), entity capabilities, entity sensors, supported activities, or the like.

The sense maker 220 can provide persistent ISR data to a patterns of life service 230. The patterns of life service 230 receives images of a specified region and analyzes the images to identify potential threats. The patterns of life service 230 can include a trained ML model that takes images an input and classifies objects in the images as either a threat or not a threat. The classification can be made on a per-pixel (a segmentation model) or per-object basis (object classification model). The patterns of life service 230 can be trained based on input examples that are labelled to indicate a desired classification per-object or per-pixel. The patterns of life service 230 can provide classification (and corresponding confidence) data to the orchestrator service 232.

The orchestrator service 232, as discussed, can issue requests for entity data from the database 240, through the entity aggregation service 238. The entity data can be for a threat, friendly, or neutral entity. The data in the database 226 can be stored in the database 240 resulting in a single database for enemies and threats.

The orchestrator service 232 can communicate with a COA analysis service 242. The COA analysis service 242 facilitates a determination of a LOS for each activity, echelon, domain, or the like through an analytic engine service 248. The COA analysis service 242 retrieves entity data through the entity aggregation service 238. The COA analysis service 242 receives mission data, such as activities, timing of the activities, entities performing the activities, weather, geography data (data regarding altitude, elevation, type of soil, permeability, buildings, waterways, roadways, or the like) or other mission data relevant to determining whether a given activity, echelon, domain, or mission will be successful. The COA analysis service 248 communicates the relevant LOS determination data to the analytic engine interface service 248.

The analytic engine interface service 248 communicates with one or more analysis engines 250. The analysis engines 250 determine LOS, a cost, an amount of collateral damage, and an amount of attribution for the activity, echelon, domain, mission, or the like. The Examples of such analysis engines include Multi-Domain Probability Assessment Capability (MDPAC) and Multi-Domain Command Acceleration Toolkit (MDCAT) from Raytheon Company. The analytic engine interface service 248 receives and retrieves data relevant to the analysis engines 250 performing their analysis. More details regarding MDPAC are provided in U.S. patent application Ser. No. 16/684,948 which is titled “Computer Architecture For Multi-Domain Probability Assessment Capability For Course of Action Analysis”, filed on Nov. 15, 2019, which is incorporated herein by reference in its entirety.

The analysis engines 250 operate using models of entities, input constraints, and the conditions of the mission using stochastic math modeling (SMM). The results of SMM indicate the LOS, the cost, the amount of collateral damage, the amount of attribution for the activity, or a variability thereof. The analysis engines 250 can operate based on threat-effect pairs in which each effect associated with a threat is intended to at least partially neutralize the threat. More details regarding threat-effect pairs are detailed in U.S. patent application Ser. No. 17/721,896 titled “Normalized Techniques for Threat Effect Pairing” and filed on Apr. 15, 2022, which is incorporated herein by reference in its entirety. The COA analysis service 242 provides the results of the analysis engines 250 to the orchestrator service 232.

The user data service 244 determines possible actions that can be taken in a given named area of interest (NAI) using entities selected by the commander, such as through the feasibility service 246. The actions can be informed based on models of the entities that indicate which actions each entity can perform.

The COA service 242 and the user data service 244 provide COA data and the possible actions that can be performed by the entities, respectively, to the feasibility service 246. The feasibility service 246 narrows down a list of all possible friendly assets that can perform the actions to only those assets that can satisfy one or more of the feasibility criterion: (i) perform a required activity of the mission, (ii) are or can be in range of the target in time, (iii) have enough fuel to reach the target, (iv) are not adversely impacted by the weather, (v) are not impacted by readiness (training), (vi) are not adversely impacted by the terrain (uses data from modified combined obstacle overlays (MCOOs)), (vii) have sufficient field of view (if a satellite), or a combination thereof. The determination performed by the feasibility service 246 can be informed based on METT_TC (Mission Enemy Terrain and Weather Troops—Time Available Civilian Considerations). METT_TC is used by the United States military to help commanders remember the considerations and prioritize what to analyze in the planning of any operation.

The METT_TC is provided by the multi-domain operations center 252, the terrain database 254, the training database 256, and the weather database 258. The center 252 provides information relevant to determining whether a satellite can fulfill any of the feasibility criterion (i)-(v) and (vii) as terrain is irrelevant for the satellites. The terrain database 254 stores information relevant to determining if an asset can satisfy criterion (vi) or (vii) as terrain can affect a field of view. The terrain database 254 can include Digital Terrain Elevation Data (DTED). DTED is a uniform matrix of terrain elevation values which provides basic quantitative data for systems and applications that use terrain elevation, slope, and/or surface roughness information. Rules in the terrain database can include data indicating which direction an entity can travel over the MCOO associated with the mission. The rules in the terrain database 254 can indicate that you cannot go in a certain direction, such as if a lake in the way (for a tank) or if a high mountain is in the way (for a plane), or if a sandbar in the ocean is in the way (for a ship).

The training database 256 stores information relevant to determining if an asset can satisfy criterion (v). The weather database 258 stores information relevant to determining if an asset can satisfy criterion (ii), (iii), (iv), and (vi) as weather can affect how far an asset can travel, how much fuel is consumed by an asset, and whether the terrain is going to be an issue. Rules in the weather database 258 include limitations of the entities depending on weather. The rules can include capabilities given weather, like max windspeed a Unmanned Air Vehicle (UAV) can fly in. The weather rules can include cloud cover restrictions for certain types of airborne sensors, rain and snow restrictions for many various types of sensors and for restrictions with respect to movement of land and air platforms (e.g., tanks and planes), or the like.

The feasibility service 246 provides data indicating which assets are available for accomplishing an activity to the orchestrator service 232.

The asset optimization service 234 takes a list of feasible assets chosen (by the commander or by default) and indicated by the feasibility service 246. The asset optimization service 234 receives time windows and activity priorities to optimize the timing of when the asset should take the action. The asset optimization service can operate using AI/ML technique. The technique can be trained in a supervised, or semi-supervised manner, such as by using a neural network (NN), a reinforcement learning (RL) technique, or other appropriate ML technique.

The mission data service 236 stores information from the commander and provides information to the commander. The mission data service 236 stores a commander intent. The commander intent can include “immobilization of an asset”, “destruction of entity”, or other mission intent. The mission data service 236 queries the entity aggregation service (EAS) 238 to create an order of battle (ORBAT) for the area of interest. The mission data service 236 provides data to the orchestrator service 232 from the commander like commander's intent and commander's objectives. The commander objectives are used to guide the COA analysis service 242 in what to put into the COA. The COA analysis service 242 is used to generate and analyze an existing COA for effectiveness. The mission data service 236 can be used pre-mission (a priori data) that is used for planning. The data from the mission data service 236 identifies the metrics and associated thresholds from the commander and complement commander intent. The metrics and thresholds are inputs to the feasibility service 246 and the COA analysis service 242.

FIG. 3 illustrates, by way of example, a diagram of an embodiment of a commander interface system 300. The commander interface system 300 interfaces with components of the architecture 200. The system 300 can be used to perform the operation 102 of FIG. 1. The system 300 coordinates mission views to be provided to the commander, such as on a SPOG, through the UI 350. The commander interacts with the UI 350 to get a view of the mission across multiple domains, echelons, or a combination thereof.

The system 300 as illustrated includes the orchestrator service 232, the analytic engine 250, sense maker 220 and space op center 252 from the system 200. The system 300 further includes components that provide data to the sense maker 220, such as a sensor orchestrator 330 and a fire and video sensor management system 332. The sensor orchestrator 330 includes communications devices that communicate with ISR devices. The sensor orchestrator 330 provides commands to the ISR devices that indicate a measurement and location at which to make a measurement or otherwise capture sensor data. The sensor orchestrator 330 receives the data from the ISR devices and formats the data for use by the sense maker 220. The sensor orchestrator 330 receives data from a collection of sensors from multiple endpoints that collect videos. The sensor orchestrator 330 feeds videos into the sense maker 220 for analysis. The fire and video sensor management system 332 allows operators to send commands to fire upon a threat. The orchestrator 330 and the system 332 help the sense maker 220 determine when and where a weapon systems will fire a round of ammunition.

The system 300 as illustrated includes an orchestrator interface 352 that communicate with the orchestrator service 232. The interface 352 includes interfaces 336, 338, 340, 342, 344, 346 to components or services that provide data relevant to the mission indicated by the commander through the UI 350. The interfaces 336, 338, 340, 342, 344, 346 can include APIs that issue messages to an active message queue 348. The active message queue 348 receives messages from the interfaces 336, 338, 340, 342, 344, 346 and the orchestrator service 232. The active message queue 348 manages incoming messages and routes the messages to a given destination, such as through one of the interfaces 336, 338, 340, 342, 344, 346 or to the orchestrator service 232.

The UI 350 provides the commander with access to the functionality of the orchestrator service 232. Using the orchestrator service 232, the functions of the components coupled through the interfaces 336, 338, 340, 342, 344, 346 are accessible through a SPOG. The orchestrator service 232 provides the UI 350 with an organized and coordinated view of the operations of a given mission and whether the mission will be successful. The commander can see data into each of the interfaces 336, 338, 340, 342, 344, 346 in separate, overlapping or non-overlapping portions, of the UI 350. The commander can customize the view provided by increasing or decreasing a size, location, or data provided in a given respective portion of the UI 350.

The commander defines what is in a COA through their objectives and intent. The commander provides NAIs and assigns activities that the blue forces will perform. These activities are then synchronized and scheduled by the orchestrator service 232 or a service coupled thereto. The COA is the selection of the entities, the selection of their activities, and the synchronization. FIG. 8 shows three alternative COA configurations on maps.

FIG. 4 illustrates, by way of example, a diagram of an embodiment of a system 400 for performing the operation 104 of FIG. 1. The system 400 is a portion of the system 200. The system 400 as illustrated includes the orchestrator service 232, the entity aggregation service 238, the mission data service 236, and the entity ingestion service 222. The system 400 further includes the database. The system 400 operates to ingest and fuse data. The sense maker 220 provides entity data, such as known specifications and location (latitude and longitude) of entities sensed or detected based on data from the sensor orchestrator 330 or the fire and video sensor management 332.

The entity ingestion service 222 receives the entity data from the sense maker 220. The entity ingestion service 222 issues a request to the aggregation service 238. The request indicates known specifications, location, and identification of the entity. The entity aggregation service 238 causes the entity data to be stored in the database 442, such as through the catalog API service 440.

The updated entity data from the entity aggregation service 238 can be provided to the orchestrator service 232, such as indirectly through the mission data service 236, or directly to the orchestrator service 232. The mission data service 236 can operate based on the new entity or new location information to perform its operations.

FIG. 5 illustrates, by way of example, a diagram of an embodiment of a chart 500 for activity synchronization, the operation 106. The synchronization and generation of the chart 500 is performed by the orchestrator service 232, through components or services coupled thereto. The chart 500 as illustrated includes temporal activity synchronization across domains. In the chart 500, time passes along the columns and different activities are listed in different rows. An filled in cell indicates that the activity in the row is to be performed at the time indicated by the corresponding column. In the chart 500, the Air Force, Space Force, and Navy domains perform data gathering operations that support activities performed by the Army, Navy, and Air Force. Different echelons within each domain are also coordinated according to the chart 500. Across the top of the chart 500, different phases for different forces (e.g., red and blue forces in the example of FIG. 5) are delineated according to time. The commander can alter the name of the phase, time of the phase, active entity during the phase, or the like.

FIG. 6 illustrates, by way of example, a diagram of an embodiment of a graphical view 600 of a mission simulation showing threat and friendly entity pairing. FIG. 6 shows a scenario in which red force threats and blue force entities will face off (i.e., be paired). This paring is the basis from which the entity models are selected and analysis is conducted. The selection corresponds to the operation 108. The orchestrator service 232 can, based on the chart 500, select models and simulation tools to be used in performing the mission analysis for the commander. Each entity and activity pair in the chart 500 can be associated with a threat. Each entity and threat pair can be associated with a model that details the capabilities of the entity relative to the threat. Each model can detail different operational parameters of the entity in performing the activity to subdue the threat, such as can be based on weather, terrain, timing, location, training, or the like.

The orchestrator service 232 can coordinate the execution of the models associated with a given mission, at operation 110. The coordination can include operating models that rely on results of another model in series and operating standalone models or series of models that do not rely on outputs of each other in parallel.

FIG. 7 illustrates, by way of example, a diagram of an embodiment of a system 700 determining the LOS, at operation 112. The LOS or other mission parameter, such as cost, collateral damage, or the like, can be determined by the COA analysis engine 250. A request for a COA analysis, based on mission data, can be issued by a commander through the UI 350. The request can include a list of activities associated with phases, list of phases, a list of entity identifications (IDs), and corresponding timing. The orchestrator service 232 can assemble the request based on based on information from the commander or a service communicatively coupled thereto. The request can be provided to the COA analysis service 242. The COA analysis service 242 can lookup entity by name or ID through the entity aggregation service 238. The entity aggregation service 238 can return a model of the entity including abilities, constraints, or the like. The entity aggregation service 238 can provide the request with corresponding entity models to the analytic engine 250.

The analytic engine 250 can include multiple analysis interfaces 336, 344. The interfaces 336, 344 provide access to functionality of different analysis engines 770, 772. The analysis engine 770 can provide the LOS, cost, collateral damage, or the like based on the request. The analysis engine 770 can operate based on the entity models, activities to be performed and corresponding criteria, and enemy COAs (eCOAs). The eCOAs are the same as the COAs, but are for the enemy instead of friendly assets and entities. More information regarding operation of the analysis engine 770 is provided in U.S. patent application Ser. No. 16/684,948 titled “Computer Architecture for Multi-Domain Probability Assessment Capability for Course of Action Analysis” and filed on Nov. 15, 2019, which is incorporated by reference herein in its entirety.

The analysis engine 772 can determine LOS, cost, collateral damage, or the like, but specifically for humans involved in the mission. The analysis engine 772 operates based on a modified combined obstacle overlay (MCOO). The analysis engine 772 considers lines of communication, physical obstacles, mobility, and other parameters to determine the LOS, cost, collateral damage, or the like. The analysis engine 772 can determine a combat power of a troop, an attrition of the troop, whether to withdraw, whether supplies are needed, or the like. The analysis engine 772 can provide a view of the operations performed by the troops.

FIGS. 8 and 9 illustrate, by way of example, diagrams of respective views that can be provided on the UI 350 as a result of the operation 114. The orchestrator service 232 receives results from the analysis engine 250 operating at operation 112 and organizes the results per domain, echelon, activity, or the like (e.g., as specified by the commander through the UI 350). The UI 800 in FIG. 8 shows a matrix view of various different COAs and their corresponding scores as determined by the analysis engine 250. The commander can alter the weight for each criteria to indicate different preferences. A higher weight typically means that the criteria has a higher importance for the given COA than a criteria with a lower weight. The criteria illustrated in FIG. 8 are LOS, cost, collateral damage, attribution, minimum amount of supplies, minimum amount of personnel, probability of kill, probability of damage, probability of locating target, minimum communications bandwidth, and maximum communications capability. Based on the weights, and the scores determined by the analysis engine 250, a score for each COA is provided. Through a quick glance, the commander can see that, in the example of FIG. 8, the COA 8 is the highest ranked COA based on the analysis.

FIG. 9 illustrates, by way of example, a diagram of an embodiment of a UI 900 that shows a full simulation of the analysis performed by the analysis engine 250. The UI 900 includes a summary section that indicates scores for each of the criteria, a duration for the COA (sometimes called a mission or a portion of a mission), The full simulation shows the relative combat powers of good force (blue forces) and enemy forces (red forces). The UI 900 further details activities, such as primary activities and supporting activities as well as respective expected hit and miss rates.

FIG. 10 illustrates, by way of example, a diagram of an embodiment of a system 1000 to perform operation 116. The system 1000 as illustrated includes services coupled to the UI 350 through the orchestrator service interfaces 352. The UI 350 can provide views from each of a plurality of services 1010, 1012, 1014, 1016, 1018, 1020, 1022, or a subset thereof, concurrently. The data from the services 1010, 1012, 1014, 1016, 1018, 1020, 1022 can be used by the system 200 and effect the output seen by the commander. The UI 350 presents views from each of the services 1010, 1012, 1014, 1016, 1018, 1020, 1022 in different regions thereof. The commander can interact with a SPOG to issue requests to and receive responses from the services 1010, 1012, 1014, 1016, 1018, 1020, 1022. The orchestrator service 232 can manage the synchronization and presentation of the results to be consistent in terms of time, representation (a globally uniform set of symbols can be used to represent assets across services 1010, 1012, 1014, 1016, 1018, 1020, 1022, units of measurement, among others.

The intelligence management service 1010 supports planning to execution of a COA using ML/AI and analytics. The service 1010 receives commands that are communicated to respective ISR devices for intelligence collection. The service 1012 coordinates and synchronizes non-kinetic (e.g., electronic warfare and cyber, for example) mission planning, targeting and COA development for offensive and defensive operations. The service 1014 is a portion of the service 352. The service 1014 analyzes images or video for indicators and warning signs for ongoing battle evolution monitoring and cost assessment. The service 1016 is the primary command and control system for planning, coordinating, controlling, and executing kinetic fires and effects. The service 1018 provides data-driven logistics regarding whether a given COA or mission is sustainable. The service 1018 determines whether to retreat, proceed as planned, or proceed with an altered plan. The service 1020 analyzes whether an asset or entity is subject to damage. The service 1020 determines what, if anything, can be done to help prevent or reduce the threatened damage. The service 1022 determines where and how assets or entities are to move and where to move in the geographic region. Each of these services exist and are not new.

Embodiments leverage techniques for making threat effect analyses compatible, such as by normalizing algorithms for threat-effect pairings. For example, generally disparate, non-comparable results are typically provided from different (threat, effect) pair models. Each (threat, effect) pair model provides results in units that are meaningful in a specific domain. For example, a model that determines an effect of an Upper Tier (UT) missile, Middle Tier (MT) missile, Lower Tier (LT) missile, mobile and ground radar, and directed energy (DE) weapon, respectively, on a threat, takes input in a different form and provides output of a different form, respectively. By normalizing the algorithms (more details elsewhere) the results of the algorithms can be easily combined, such as by addition, to simulate various combinations of (threat, effect) pairs. Normalizing the algorithms converts algorithm results for (threat, effect) pairs into equivalent units (e.g., for UT, MT, LT, mobile and ground radar, and DE (threat, effect) pairs).

Normalizing algorithms provides an algorithm construction framework that enables the creation of (threat, effect) pairable algorithms such that, when populated with data, the results can be compared and combined for the same tasks and for varying tasks (e.g., with respect to metric units, magnitudes, dimensions, a combination thereof or the like). Combining algorithm results from different, normalized algorithms helps provide mission assessment based on sharing intermediate products (e.g., confidence intervals). Normalized algorithms can be stored in a repository of unique algorithms for mission assessment with a definite analytic discriminator.

Embodiments are described generally with regard to projectiles, radar, cyber, and DE type threats and effects, but can include other threats and effects. The threats can be kinetic, such as to inflict damage through object motion through air. The threats can be non-kinetic, such as to inflict damage through a medium other than motion through air, such as electrical, chemical, social, or the like. Similarly, the effects can be kinetic or non-kinetic, but instead of inflicting damage, the effects mitigate the damage. A goal of a mission can generally be to reduce damage inflicted on an entity performing mission planning.

Embodiments can help aid a mission planner in determining which effects to deploy to physically mitigate the effects. Embodiments can do this by normalizing the algorithms in a way that allows results of the algorithms to be combined with simple mathematical operations. Other advantages of such normalization are realized and described in U.S. patent application Ser. No. 17/721,896 titled “Normalized Techniques for Threat Effect Pairing” and filed on Apr. 15, 2022, which is incorporated herein by reference in its entirety.

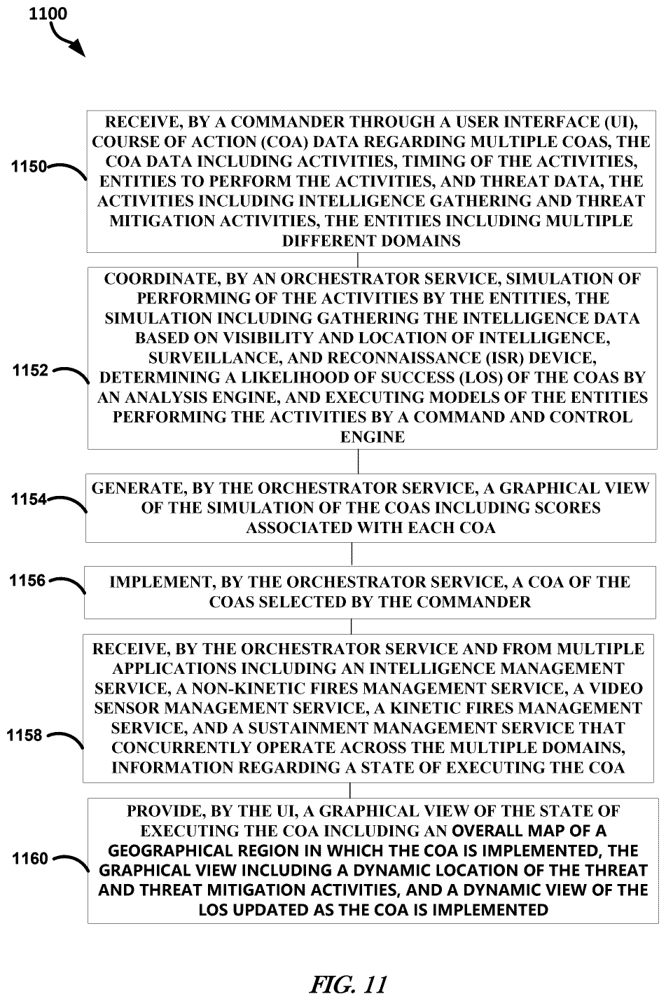

FIG. 11 illustrates, by way of example, a diagram of an embodiment of a method 1100 for [symbol] . The method 1100 as illustrated includes receiving, by a commander through a user interface (UI), course of action (COA) data regarding multiple COAs, the COA data including activities, timing of the activities, entities to perform the activities, and threat data, the activities including intelligence gathering and threat mitigation activities, the entities including multiple different domains, at operation 1150; coordinating, by an orchestrator service, simulation of performing of the activities by the entities, the simulation including gathering the intelligence data based on visibility and location of intelligence, surveillance, and reconnaissance (ISR) device, determining a likelihood of success (LOS) of the COAs by an analysis engine, and executing models of the entities performing the activities by a command and control engine, at operation 1152; generating, by the orchestrator service, a graphical view of the simulation of the COAs including scores associated with each COA, at operation 1154; implementing, by the orchestrator service, a COA of the COAs selected by the commander, at operation 1156; receiving, by the orchestrator service and from multiple applications including an intelligence management service, a non-kinetic fires management service, a video sensor management service, a kinetic fires management service, and a sustainment management service that concurrently operate across the multiple domains, information regarding a state of executing the COA, at operation 1158; and providing, by the UI, a graphical view of the state of executing the COA including an overall map of a geographical region in which the COA is implemented, the graphical view including a dynamic location of the threat and threat mitigation activities, and a dynamic view of the LOS updated as the COA is implemented, at operation 1160.

The method 1100 can further include determining, by a feasibility service communicatively coupled to the orchestration service, entities that are capable of performing each activity, and for each entity that is capable, are in range to perform the activity, can operate in weather conditions of a geographic region corresponding to the activity, and can operate in terrain of the geographical region resulting in feasible entities. The method 1100 can further include providing, to the commander and by the UI, for each activity of the activities that has multiple feasible entities, a software control through which the commander selects a feasible entity of the multiple feasible entities. The method 1100 can further include receiving, by the commander and through the UI, a selection of the feasible entity of the feasible entities for each activity of the activities that has multiple feasible entities.

The method 1100 can further include receiving, by a user data service communicatively coupled to the orchestration service, possible actions that can be performed by each feasible entity selected for each activity. The method 1100 can further include receiving, from the commander and through the UI, a selection of machine learning (ML) tools. The method 1100 can further include coordinating, by the orchestration service, operation of the ML tools in the simulation.

The method 1100 can further include, wherein the ML tools include an asset optimization service that determines, for each feasible entity of the feasible entities, a time that the entity is to take action to perform a corresponding activity of the activities. The method 1100 can further include, wherein the ML tools include a patterns of life service that monitors the geographical region for a new threat. The method 1100 can further include receiving, by the orchestration service and from an alert service communicatively coupled to the orchestration service, an alert indicating an updated location that is a change in location of the threat. The method 1100 can further include providing, by the orchestration service, the updated location to the ML tools, the COA analysis engine, the video sensor management service, the kinetic fires management service, and the sustainment management service. The method 1100 can further include receiving, by the orchestrator service, based on the updated location, and from the multiple applications, updated information regarding a new state of executing the COA.

The method 1100 can further include, wherein the graphical view and results are all provided on a single pane of glass (SPOG).

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as classification, device behavior modeling (as in the present application) or the like. The patterns of life service 230, asset optimization service 234, or other component or operation can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

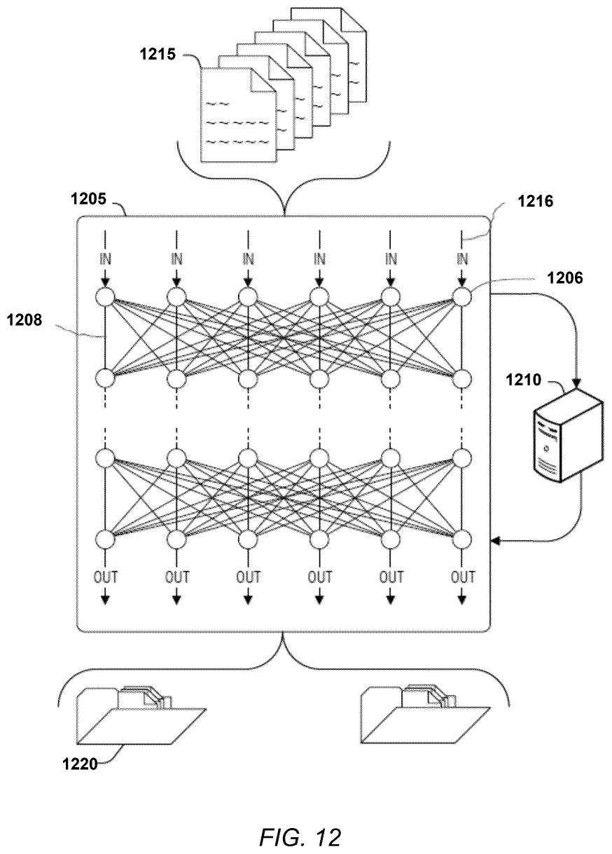

FIG. 12 is a block diagram of an example of an environment including a system for neural network (NN) training. The system includes an artificial NN (ANN) 1205 that is trained using a processing node 1210. The processing node 1210 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 1205, or even different nodes 1207 within layers. Thus, a set of processing nodes 1210 is arranged to perform the training of the ANN 1205. The patterns of life service 230, asset optimization service 234, or the like, can be trained using the system.

The set of processing nodes 1210 is arranged to receive a training set 1215 for the ANN 1205. The ANN 1205 comprises a set of nodes 1207 arranged in layers (illustrated as rows of nodes 1207) and a set of inter-node weights 1208 (e.g., parameters) between nodes in the set of nodes. In an example, the training set 1215 is a subset of a complete training set. Here, the subset may enable processing nodes with limited storage resources to participate in training the ANN 1205.

The training data may include multiple numerical values representative of a domain, such as an image feature, or the like. Each value of the training or input 1217 to be classified after ANN 1205 is trained, is provided to a corresponding node 1207 in the first layer or input layer of ANN 1205. The values propagate through the layers and are changed by the objective function.

As noted, the set of processing nodes is arranged to train the neural network to create a trained neural network. After the ANN is trained, data input into the ANN will produce valid classifications 1220 (e.g., the input data 1217 will be assigned into categories), for example. The training performed by the set of processing nodes 1207 is iterative. In an example, each iteration of the training the ANN 1205 is performed independently between layers of the ANN 1205. Thus, two distinct layers may be processed in parallel by different members of the set of processing nodes. In an example, different layers of the ANN 1205 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 1207 (e.g., neurons) are trained independently. In an example, the nodes are trained on different hardware.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

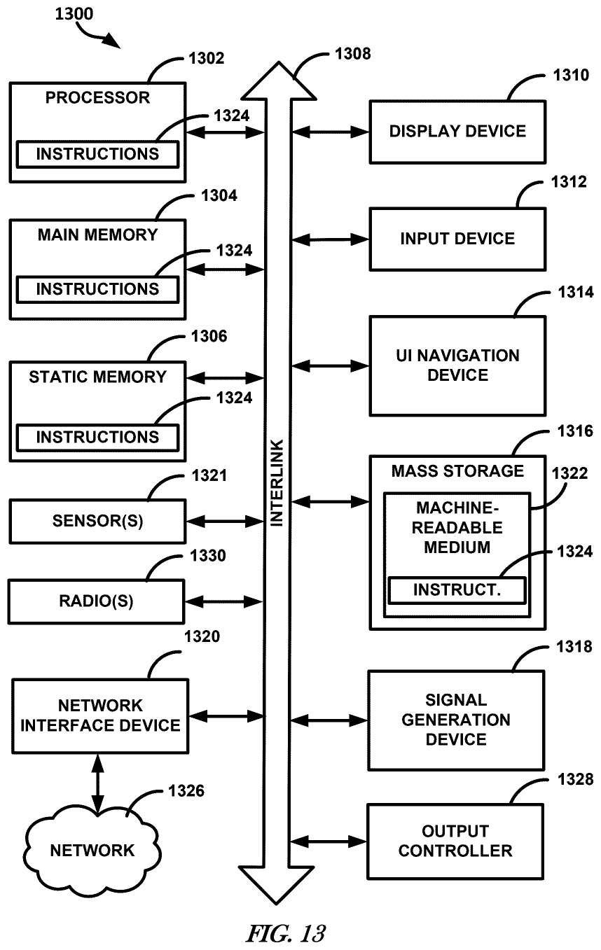

FIG. 13 illustrates, by way of example, a block diagram of an embodiment of a machine in the example form of a computer system 1300 within which instructions, for causing the machine to perform any one or more of the methodologies discussed herein, may be executed. One or more of the method 1100 or other method or operation thereof can be implemented or performed by the computer system 1300. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 1321 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a user interface (UI) navigation device 1314 (e.g., a mouse), a disk drive unit 1316, a signal generation device 1318 (e.g., a speaker), a network interface device 1320, and radios 1330 such as Bluetooth, WWAN, WLAN, and NFC, permitting the application of security controls on such protocols.

The machine 1300 as illustrated includes an output controller 1328. The output controller 1328 manages data flow to/from the machine 1300. The output controller 1328 is sometimes called a device controller, with software that directly interacts with the output controller 1328 being called a device driver.

### Machine-Readable Medium

The disk drive unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304, the static memory 1306, and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding, or carrying instructions for execution by the machine and that cause the machine to perform any one or more of the methodologies of the present invention, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL EXAMPLE

Example 1 includes a method for mission planning and execution, the method comprising receiving, by a commander through a user interface (UI), course of action (COA) data regarding multiple COAs, the COA data including activities, timing of the activities, entities to perform the activities, and threat data, the activities including intelligence gathering and threat mitigation activities, the entities including multiple different domains, coordinating, by an orchestrator service, simulation of performing of the activities by the entities, the simulation including gathering the intelligence data based on visibility and location of intelligence, surveillance, and reconnaissance (ISR) device, determining a likelihood of success (LOS) of the COAs by an analysis engine, and executing models of the entities performing the activities by a command and control engine, generating, by the orchestrator service, a graphical view of the simulation of the COAs including scores associated with each COA, implementing, by the orchestrator service, a COA of the COAs selected by the commander, receiving, by the orchestrator service and from multiple applications including an intelligence management service, a non-kinetic fires management service, a video sensor management service, a kinetic fires management service, and a sustainment management service that concurrently operate across the multiple domains, information regarding a state of executing the COA, and providing, by the UI, a graphical view of the state of executing the COA including an overall map of a geographical region in which the COA is implemented, the graphical view including a dynamic location of the threat and threat mitigation activities, and a dynamic view of the LOS updated as the COA is implemented.

In Example 2, Example 1 can further include determining, by a feasibility service communicatively coupled to the orchestration service, entities that are capable of performing each activity, and for each entity that is capable, are in range to perform the activity, can operate in weather conditions of a geographic region corresponding to the activity, and can operate in terrain of the geographical region resulting in feasible entities, providing, to the commander and by the UI, for each activity of the activities that has multiple feasible entities, a software control through which the commander selects a feasible entity of the multiple feasible entities, and receiving, by the commander and through the UI, a selection of the feasible entity of the feasible entities for each activity of the activities that has multiple feasible entities.

In Example 3, Example 2 can further include receiving, by a user data service communicatively coupled to the orchestration service, possible actions that can be performed by each feasible entity selected for each activity.

In Example 4, at least one of Examples 2-3 further includes receiving, from the commander and through the UI, a selection of machine learning (ML) tools, and coordinating, by the orchestration service, operation of the ML tools in the simulation.

In Example 5, Example 4 further includes, wherein the ML tools include an asset optimization service that determines, for each feasible entity of the feasible entities, a time that the entity is to take action to perform a corresponding activity of the activities.

In Example 6, at least one of Examples 4-5 further includes, wherein the ML tools include a patterns of life service that monitors the geographical region for a new threat.

In Example 7, at least one of Examples 4-6 further includes receiving, by the orchestration service and from an alert service communicatively coupled to the orchestration service, an alert indicating an updated location that is a change in location of the threat, and providing, by the orchestration service, the updated location to the ML tools, the COA analysis engine,.

In Example 8, Example 7 further includes, wherein the graphical view, results, are all provided on a single pane of glass (SPOG).

In Example 9, a non-transitory machine-readable medium including instructions that, when executed by a machine, cause the machine to perform the method of one or more of Examples 1-8.

In Example 10, a system configured to perform the method of one or more of Examples 1-8.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method for mission planning and execution, the method comprising:
receiving, by a commander through a user interface (UI), course of action (COA) data regarding multiple COAs, the COA data including activities, timing of the activities, entities to perform the activities, and threat data, the activities including intelligence gathering and threat mitigation activities, the entities including multiple different domains;
coordinating, by an orchestrator service, simulation of performing of the activities by the entities, the simulation including gathering the intelligence data based on visibility and location of intelligence, surveillance, and reconnaissance (ISR) device, determining a likelihood of success (LOS) of the COAs by an analysis engine, and executing models of the entities performing the activities by a command and control engine;
generating, by the orchestrator service, a graphical view of the simulation of the COAs including scores associated with each COA;
implementing, by the orchestrator service, a COA of the COAs selected by the commander;
receiving, by the orchestrator service and from multiple applications including an intelligence management service, a non-kinetic fires management service, a video sensor management service, a kinetic fires management service, and a sustainment management service that concurrently operate across the multiple domains, information regarding a state of executing the COA; and
providing, by the UI, a graphical view of the state of executing the COA including an overall map of a geographical region in which the COA is implemented, the graphical view including a dynamic location of the threat and threat mitigation activities, and a dynamic view of the LOS updated as the COA is implemented.

2. The method of claim 1, further comprising:
determining, by a feasibility service communicatively coupled to the orchestration service, entities that are capable of performing each activity, and for each entity that is capable, are in range to perform the activity, can operate in weather conditions of a geographic region corresponding to the activity, and can operate in terrain of the geographical region resulting in feasible entities;
providing, to the commander and by the UI, for each activity of the activities that has multiple feasible entities, a software control through which the commander selects a feasible entity of the multiple feasible entities; and
receiving, by the commander and through the UI, a selection of the feasible entity of the feasible entities for each activity of the activities that has multiple feasible entities.

3. The method of claim 2, further comprising:
receiving, by a user data service communicatively coupled to the orchestration service, possible actions that can be performed by each feasible entity selected for each activity.

4. The method of claim 2, further comprising:
receiving, from the commander and through the UI, a selection of machine learning (ML) tools; and
coordinating, by the orchestration service, operation of the ML tools in the simulation.

5. The method of claim 4, wherein the ML tools include an asset optimization service that determines, for each feasible entity of the feasible entities, a time that the entity is to take action to perform a corresponding activity of the activities.

6. The method of claim 4, wherein the ML tools include a patterns of life service that monitors the geographical region for a new threat.

7. The method of claim 4, further comprising:
receiving, by the orchestration service and from an alert service communicatively coupled to the orchestration service, an alert indicating an updated location that is a change in location of the threat;
providing, by the orchestration service, the updated location to the ML tools, the COA analysis engine, the video sensor management service, the kinetic fires management service, and the sustainment management service; and
receiving, by the orchestrator service, based on the updated location, and from the multiple applications, updated information regarding a new state of executing the COA.

8. The method of claim 7, wherein the graphical view and the results, are all provided on a single pane of glass (SPOG).

9. A non-transitory machine-readable medium including instructions that, when executed by a machine, cause the machine to perform operations for mission planning and execution, the operations comprising:
receiving, by a commander through a user interface (UI), course of action (COA) data regarding multiple COAs, the COA data including activities, timing of the activities, entities to perform the activities, and threat data, the activities including intelligence gathering and threat mitigation activities, the entities including multiple different domains;
coordinating simulation of performing of the activities by the entities, the simulation including gathering the intelligence data based on visibility and location of intelligence, surveillance, and reconnaissance (ISR) device, determining a likelihood of success (LOS) of the COAs by an analysis engine, and executing models of the entities performing the activities by a command and control engine;
generating a graphical view of the simulation of the COAs including scores associated with each COA;
implementing a COA of the COAs selected by the commander;
receiving from multiple applications including an intelligence management service, a non-kinetic fires management service, a video sensor management service, a kinetic fires management service, and a sustainment management service that concurrently operate across the multiple domains, information regarding a state of executing the COA; and
providing, by the UI, a graphical view of the state of executing the COA including an overall map of a geographical region in which the COA is implemented, the graphical view including a dynamic location of the threat and threat mitigation activities, and a dynamic view of the LOS updated as the COA is implemented.

10. The non-transitory machine-readable medium of claim 9, wherein the operations further comprise:
receiving, from a feasibility service, entities that are capable of performing each activity, are in range to perform the activity, can operate in weather conditions of a geographic region corresponding to the activity, and can operate in terrain of the geographical region resulting in feasible entities; and
providing, to the commander and by the UI, for each activity of the activities that has multiple feasible entities, a software control through which the commander selects a feasible entity of the multiple feasible entities; and
receiving, by the commander and through the UI, a selection of the feasible entity of the feasible entities for each activity of the activities that has multiple feasible entities.

11. The non-transitory machine-readable medium of claim 10, wherein the operations further comprise:
receiving, by a user data service communicatively coupled to the orchestration service, possible actions that can be performed by each feasible entity selected for each activity.

12. The non-transitory machine-readable medium of claim 10, wherein the operations further comprise:
receiving, from the commander and through the UI, a selection of machine learning (ML) tools; and
coordinating, by the orchestration service, operation of the ML tools in the simulation.

13. The non-transitory machine-readable medium of claim 12, wherein the ML tools include an asset optimization service that determines, for each feasible entity of the feasible entities, a time that the entity is to take action to perform a corresponding activity of the activities.

14. The non-transitory machine-readable medium of claim 12, wherein the ML tools include a patterns of life service that monitors the geographical region for a new threat.

15. The non-transitory machine-readable medium of claim 12, wherein the operations further comprise:
receiving, from an alert service, an alert indicating an updated location that is a change in location of the threat;
providing the updated location to the ML tools, the COA analysis engine, the video sensor management service, the kinetic fires management service, and the sustainment management service; and
receiving, based on the updated location and from the multiple applications, updated information regarding a new state of executing the COA.

16. A system comprising:
processing circuitry;
a display;
a memory coupled to the processing circuitry and the display, the memory including instructions that, when executed by the processing circuitry, cause the processing circuitry to perform operations for mission planning and execution, the operations comprising:
receiving, by a commander through a user interface (UI) of the display, course of action (COA) data regarding multiple COAs, the COA data including activities, timing of the activities, entities to perform the activities, and threat data, the activities including intelligence gathering and threat mitigation activities, the entities including multiple different domains;
coordinating, by an orchestrator service, simulation of performing of the activities by the entities, the simulation including gathering the intelligence data based on visibility and location of intelligence, surveillance, and reconnaissance (ISR) device, determining a likelihood of success (LOS) of the COAs by an analysis engine, and executing models of the entities performing the activities by a command and control engine;
generating, by the orchestrator service, and providing, by the display, a graphical view of the simulation of the COAs including scores associated with each COA;
implementing a COA of the COAs selected by the commander;
receiving from multiple applications including an intelligence management service, a non-kinetic fires management service, a video sensor management service, a kinetic fires management service, and a sustainment management service that concurrently operate across the multiple domains, information regarding a state of executing the COA; and
providing, by the UI, a graphical view of the state of executing the COA including an overall map of a geographical region in which the COA is implemented, the graphical view including a dynamic location of the threat and threat mitigation activities, and a dynamic view of the LOS updated as the COA is implemented.

17. The system of claim 16, wherein the operations further comprise:
determining, by a feasibility service communicatively coupled to the orchestration service, entities that are capable of performing each activity, and for each entity that is capable, are in range to perform the activity, can operate in weather conditions of a geographic region corresponding to the activity, and can operate in terrain of the geographical region resulting in feasible entities; and
providing, to the commander and by the UI, for each activity of the activities that has multiple feasible entities, a software control through which the commander selects a feasible entity of the multiple feasible entities; and
receiving, by the commander and through the UI, a selection of the feasible entity of the feasible entities for each activity of the activities that has multiple feasible entities.

18. The system of claim 17, wherein the operations further comprise:
receiving, by a user data service communicatively coupled to the orchestration service, possible actions that can be performed by each feasible entity selected for each activity.

19. The system of claim 17, wherein the operations further comprise:
receiving, from the commander and through the UI, a selection of machine learning (ML) tools; and
coordinating, by the orchestration service, operation of the ML tools in the simulation.

20. The system of claim 19, wherein the operations further comprise:
receiving, from an alert service communicatively coupled to the orchestration service, an alert indicating an updated location that is a change in location of the threat;
providing the updated location to the ML tools, the COA analysis engine, the video sensor management service, the kinetic fires management service, and the sustainment management service; and
receiving, based on the updated location and from the multiple applications, updated information regarding a new state of executing the COA.
